(19) United States
(12) Patent Application Publication
(10) Pub. No.: US 2013/0213738 A1
(43) Pub. Date: Aug. 22, 2013

(54) Compact Folding Step Stool

(71) Applicant: John S. Schroeder, Lake Havasu City, AZ (US)

(72) Inventor: John S. Schroeder, Lake Havasu City, AZ (US)

(21) Appl. No.: 13/769,320

(22) Filed: Feb. 16, 2013

Related U.S. Application Data
(60) Provisional application No. 61/600,500, filed on Feb. 17, 2012.

(51) Int. Cl. E06C 9/06

(52) U.S. Cl. CPC E06C 9/06
USPC 182/90

(57) ABSTRACT

A quick folding step stool is provided that folds compactly enough to fit in a cabinet toe-kick area while requiring no modifications to existing cabinets. The quick folding step stool can also be mounted on a track to move laterally along a bank of cabinets. The quick folding step stool or the track can also be mounted on a wall, behind a bar, in a work area, or in any other location where occasional access to higher shelves or other features is required.

### FIELD OF THE INVENTION

This invention relates to collapsible steps and, more particularly, to compact collapsible steps which can be mounted on existing walls or cabinets and are movable along the wall or row of cabinets.

### BACKGROUND OF THE INVENTION

In most buildings, the height of the walls is much greater than the height of the building occupants. When shelves are mounted on a wall, they are typically mounted to likewise extend higher than most can reach. This situation is common in residential kitchens, pantries, closets, and garages. It is also a common issue in commercial facilities with storage rooms, kitchens, filing rooms, computer rooms, and other similar rooms where space is at a premium. The most common solution to this problem is the use of a step stool. However, in areas where space is at a premium, it can be difficult to store a step stool without interfering with the use of the space, and the stool may be stored in a distant location and be difficult to access. If the stool is stored in a cabinet or similar storage area, it takes up valuable storage space. It is therefore desirable to have a step stool which can be easily stored near the area of intended use, while requiring little or no extra space to store it.

A number of step stools have been designed to hide away by folding or collapsing, but almost all existing solutions require either valuable storage space or require significant modifications to the cabinets or walls.

U.S. Pat. No. 6,880,673 issued to George Harris discloses a step assembly which mounts to a cabinet facing, and collapses to a narrow profile capable of mounting beneath the overhang in the toe-kick area of a standard kitchen cabinet. When pressed, the step assembly extends away from the cabinet and the resulting step can be lifted into position. The step disclosed in this patent has a number of drawbacks. First, it is fixed to the cabinet and cannot be moved to other locations. Second, the step, when extended and raised, rises on a vertical support with minimal capability for lateral stabilization other than small flanges on the bottom of the supports. This makes the step susceptible to overturning.

U.S. Patent Application 2004/0251080 filed by Kalos discloses an extensible step designed for installation in the base of a cabinet. However, the mechanism disclosed by Kalos requires substantial modification of the cabinets to accommodate the installation of the step. Furthermore, the step extends well out from the cabinets when deployed, creating an increased hazard of tripping. Finally, the Kalos device is mounted in a single location on the cabinets and cannot be moved to different locations as needed.

U.S. Patent Application 2004/0262082 filed by Bay also discloses an extensible step designed for installation in the base of a cabinet. The mechanism disclosed by Bay also retracts behind the back of the toe-kick area, so substantial modification of the cabinets is required to accommodate the installation of the step. The Bay mechanism includes a step that rises vertically from the extended main step, as well as lights integrated into the step. However, the step extends well out from the cabinets when deployed, creating an increased hazard of tripping. Additionally, the Bay device is mounted in a single location on the cabinets and cannot be moved to different locations as needed. Finally, the Bay device is not suitable for mounting on an unmodified wall, since it requires a large area to retract.

U.S. Pat. No. 2,881,040 issued to Hartridge discloses a step stool designed to be mounted on a rail in the toe-kick area and which folds into a cabinet. The mechanism disclosed by Hartridge is not collapsible and takes up a substantial amount of storage space in the block of cabinets. The Hartridge device is therefore not suitable for use along an unmodified wall, since it requires a large amount of space to store.

It is therefore apparent that there is an established need for a step stool that collapses into a minimal size when not in use, that is safe and stable when extended, that is easily repositioned for use in different areas, and that does not require significant modifications to installed cabinets, walls, or other mounting surfaces.

### SUMMARY OF THE INVENTION

The present invention describes a quick folding step stool that collapses to a narrow profile to utilize a portion of the toe-kick area available under a cabinet overhang and avoid taking up valuable cabinet space. Furthermore, the quick folding step stool of the current invention requires no modification of the cabinets, requiring only the mounting of a track on the existing backing face. Additionally, the quick folding step stool of the present invention can be moved from place to place along the cabinet, making it easy to reposition to facilitate access to many shelves with minimal installation requirements. Furthermore, the quick folding step stool of the present invention offers significant additional benefits when it is incorporated into the design of the cabinets rather than being merely an addition to existing cabinets. As an alternative to the track mounted on the face of the toe-kick area backing, the track can be embedded in the floor of the kitchen or on the top of the toe-kick area. Alternatively, the cabinet face in the toe-kick area can be replaced with concrete to further enhance the stability of the quick folding step stool.

The quick folding step stool of the present invention can also be enhanced with the addition of power, either from the house lines or from a battery module on the track or the step module. The addition of electric power allows for the addition of lights to the step stool or to the rail, allowing the option of lighting the toe-kick area with single or multicolor lights. Furthermore, the addition of electric power allows the step module to be motorized, providing the ability to move automatically along the track or to extend and collapse automatically. The movement or extension of the step unit can be controlled either remotely or with a switch embedded in the wall.

Additionally, the quick folding step stool of the present invention has a very thin profile, allowing use in areas without an overhang or toe-kick area with a minimal danger of tripping.

An object of this invention is to provide a step stool which is easy to use.

A further object of this invention is to provide a step stool that collapses into a small space, so that it is not a tripping hazard.

An additional object of this invention is to provide a step stool that can be easily relocated to different locations along a track.

Another object of this invention is to provide a step stool that is permanently connected to a wall and therefore cannot be misplaced.

A further object of this invention is to provide a step stool that can be configured to open automatically.

An additional object of this invention is to provide a step stool that can be configured to move along the wall automatically.

Another object of this invention is to provide a step stool with a track that can be lighted for decorative effect.

A further object of this invention is to provide a step stool with a track that can be lighted to provide a safer floor environment.

### BRIEF DESCRIPTION OF THE DRAWINGS

The preferred embodiments of the invention will hereinafter be described in conjunction with the appended drawings, provided to illustrate and not to limit the invention, where like designations denote like elements, and in which:

FIG. 1 provides an isometric view of a first embodiment of the quick folding step stool of the present invention;

FIG. 2 provides a front view of the first embodiment of the quick folding step stool of the present invention;

FIG. 3 provides a back view of the first embodiment of the quick folding step stool of the present invention;

FIG. 4 provides a side view of the first embodiment of the quick folding step stool of the present invention;

FIG. 5 provides a front view of the quick folding step stool of the present invention mounted on a block of cabinets;

FIG. 6 provides a side view of the quick folding step stool of the present invention mounted on a block of cabinets;

FIG. 7 provides a side view of a second embodiment of the quick folding step stool of the present invention;

FIG. 8 provides a front elevation view of a fourth embodiment of the quick folding step stool of the present invention;

FIG. 9 provides a side view of a fourth embodiment of the quick folding step stool of the present invention;

FIG. 10 provides a front view of a fourth embodiment of the quick folding step stool of the present invention; and

FIG. 11 depicts an isometric view of a fifth embodiment of the compact quick folding step stool of the present invention.

Like reference numerals refer to like parts throughout the several views of the drawing.

### DETAILED DESCRIPTION

Shown throughout the figures, the present invention is directed toward a collapsible step stool which folds quickly and compactly to a size able to fit in a cabinet toe-kick area and which requires no modifications to existing cabinets for installation.

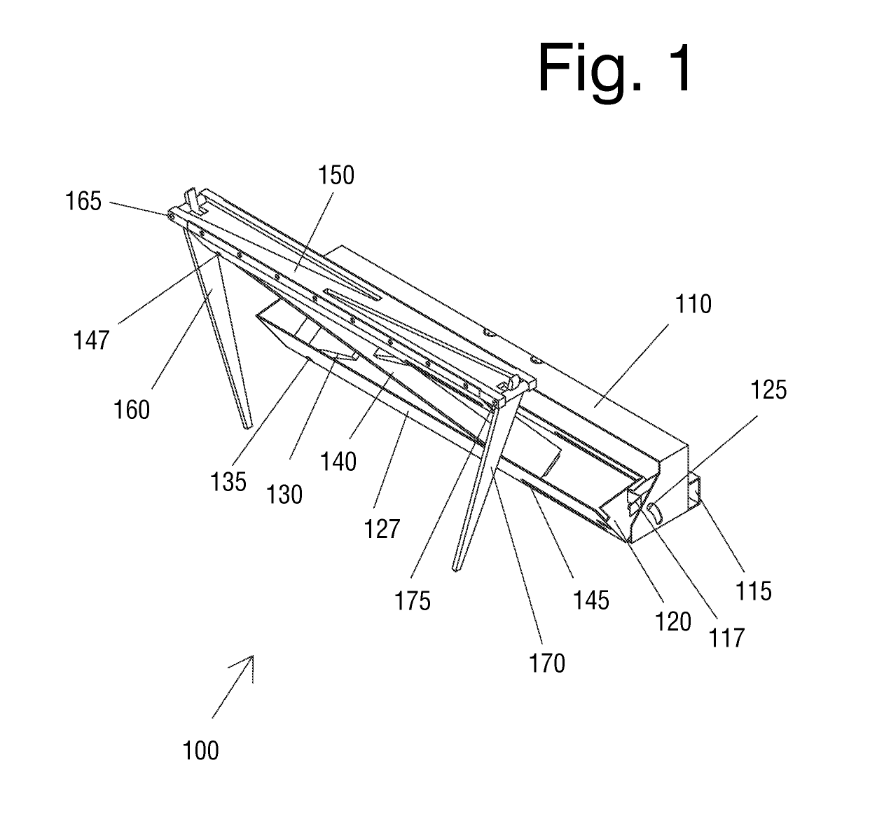

FIG. 1 depicts an isometric view of the first embodiment of the compact quick folding step stool of the present invention. The base of the compact quick folding step stool 100 is a mounting brace housing 110 which houses the extension mechanism, any support stands, step 150, and associated components of the step stool 100 when retracted. An extension mechanism is affixed to, and configured to retract into, the mounting brace housing 110. The extension mechanism includes a rotating housing 120, rear cross member 130, and front cross member 140.

The rotating housing 120 is connected to the mounting brace housing 110 by a sliding pin 125. The rotating housing 120 can be shaped in a variety of ways, but is preferably configured to present a flat face 127 when rotated into the mounting brace housing 110. In this first embodiment, the rotating housing is maintained in a closed position by a housing catch 117 configured as a flexible piece of metal attached to the mounting brace housing 110 above the sliding pin 125 and extending forward to the edge of the rotating housing 120. The housing catch 117 is bent so that a portion extends in front of the rotating housing 120 preventing it from rotating forward until the housing catch 117 is released. However, the housing catch 117 may utilize any standard latch mechanism, may be an electro-mechanical switch, or may be a mechanism that can be activated by a computer system or an electrical system, either hardwired or by remote control.

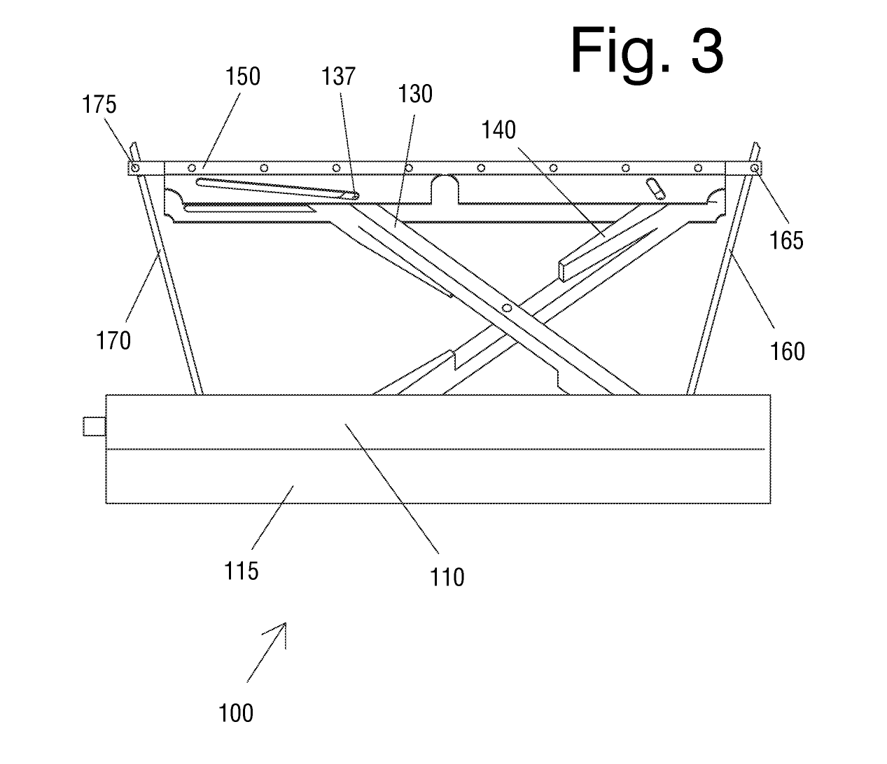

A rear cross member 130 is mounted to the rotating housing face 127 with a rear cross member pivot 135, and a front cross member 140 is mounted to the rotating housing face 127 with a front cross member sliding pin 145 that is configured to catch when fully engaged. The rear cross member pivot 135 and the front cross member sliding pin 145 connect to appropriate interlocks provided in the rotating housing face 127. The rear cross member 130 and the front cross member 140 are mounted to cross above the rotating housing 120, and are shaped so that they do not interfere with each other as the assembly is extended or retracted. The rear cross member 130 and the front cross member 140 mount to a step 150 above their crossing point. In this embodiment, the front cross member 140 is mounted to the step 150 by a front cross member pivot 147, and the rear cross member 130 is mounted to the step 150 by a sliding pin 137 (FIG. 3).

In this first embodiment, the rear cross member pivot 135 and the rear sliding pin 137 (FIG. 3) are formed as a unit with the rear cross member 130. Likewise, the front cross member sliding pin 145 and the front cross member pivot 147 are formed as a unit with the front cross member 140. Optionally, the pins may be formed separately and attached to the cross members using any standard secure connection, such as a welded connection, retainer clips, or bolts with locking nuts. Furthermore, the connections between the step 150 and the cross members 130 and 140, and the connections between the cross members 130 and 140 and the rotating housing 120 are not restricted to pivots and sliding pins, but could optionally be any suitable connector which provides sufficient lateral movement to allow the cross members 130 and 140 to be extended and retracted. The cross members 130 and 140 can also optionally be configured with a spring mounted between the lower ends near the rear cross member pivot 135 and the front cross member sliding pin 145, or with a spring mounted between the upper ends near the rear cross member pivot 135 and the rear sliding pin 137 (FIG. 3), or in both locations. This spring can assist in lifting the step 150 into position or, if strong enough, can serve to extend the step 150 automatically upon release of the housing catch 117.

The cross members 130 and 140 can further be optionally configured with a motor which drives a worm gear, screw drive, belt drive, or other type of linear actuator mounted between the lower ends near the rear cross member pivot 135 and the front cross member sliding pin 145. The motor can be configured to extend or retract the step 150 under the control of an electrical or computer system.

This first embodiment of the compact quick folding step stool 100 also provides for a left stabilizing stand 160 mounted to the left hand side of the step 150 with a left stabilizing stand pivot 165 and a right stabilizing stand 170 mounted to the right side of the step 150 with a right stabilizing stand pivot 175. Although the rear cross member 130 and the front cross member 140 can be made strong enough to support a person's weight, the left stabilizing stand 160 and the right stabilizing stand 170 provide additional stability and support, while reducing the strain on the rear cross member 130 and the front cross member 140, as well as on the track mount 115 and other parts of the step stool 100. The left stabilizing stand pivot 165 and the right stabilizing stand pivot 175 are mounted parallel to the rear cross member pivot, allowing the left stabilizing stand 160 and the right stabilizing stand 170, respectively, to lay on top of the step 150 when collapsed, but to rotate up and around roughly 270 degrees to be finally positioned substantially vertically in order to provide additional support and stability to the step 150.

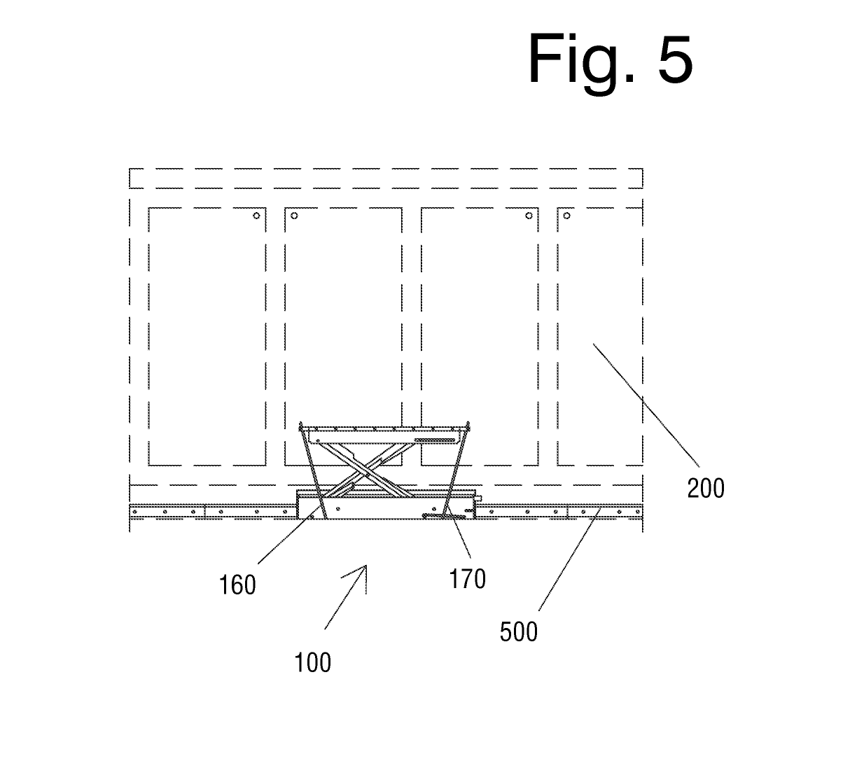

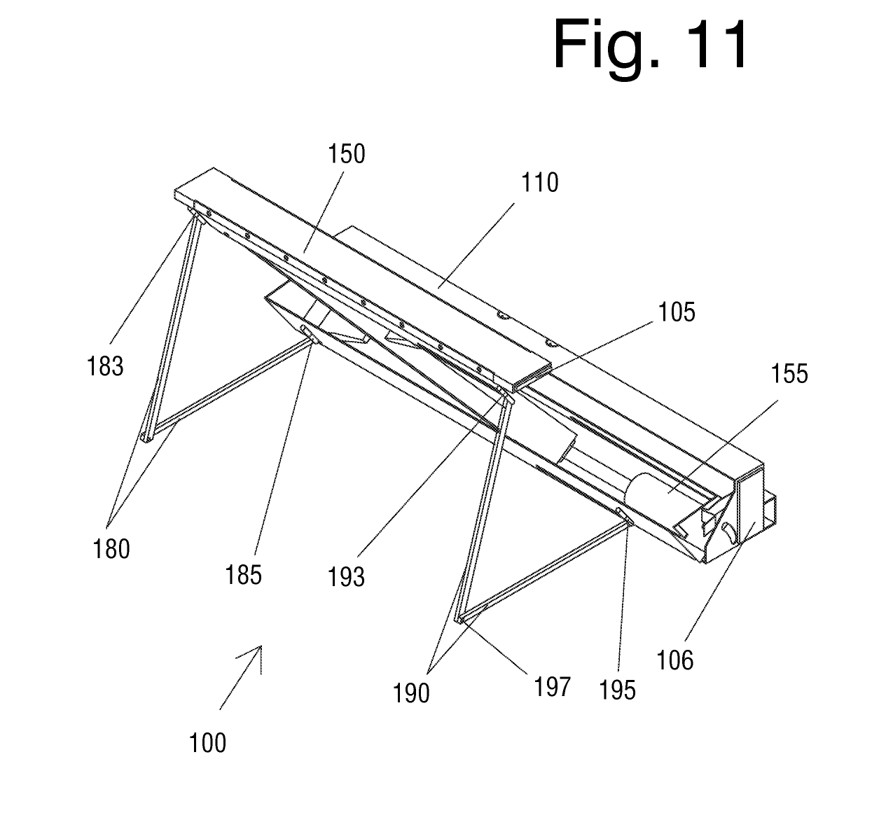

In addition to the rotating housing 120 and assembly of the extension mechanism, a track mount 115 is mounted to the back of the mounting brace housing 110 which allows the step stool 100 to be mounted on a track 500 (FIG. 5). The track mount 115 allows easy lateral movement, so that the step stool 100 can be repositioned in any location along the track 500 (FIG. 5). The compact quick folding step stool 100 can also be enhanced with a motor 155 (FIG. 11) capable of automatically moving the step stool 100 along the track 500 (FIG. 5) based on electrical or mechanical input, such as from a switch or other mechanism, or from an electrical or computer system, either hardwired or by remote control. Furthermore, a power source 106 (FIG. 11), optionally providing battery power or household electrical power, can be provided as necessary for the compact quick folding step stool 100 in order to power on-board motors or lighting 155, as desired.

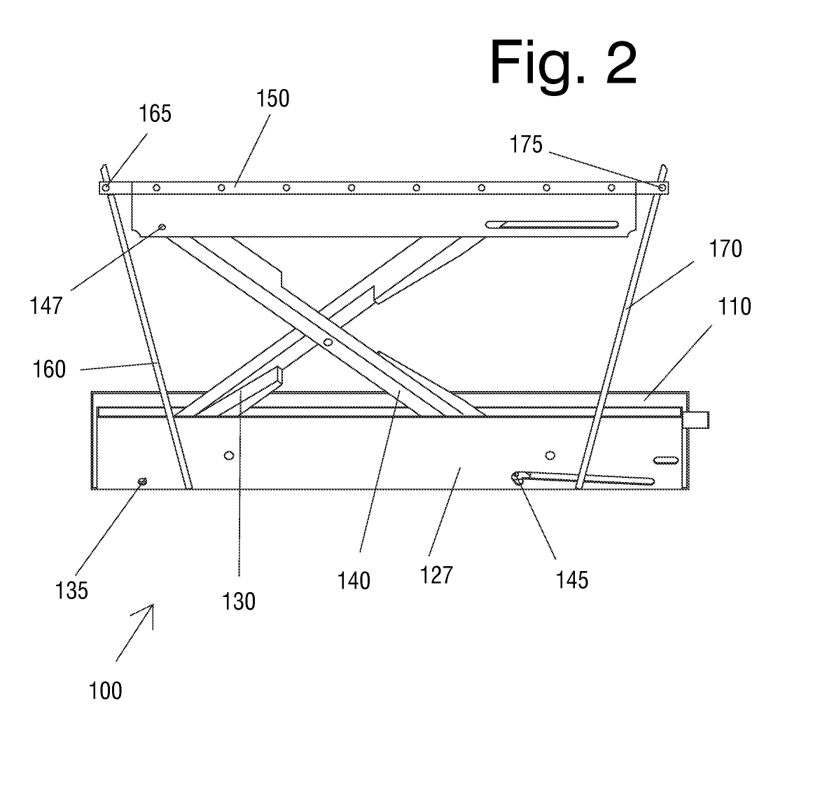

FIG. 2 presents a front view of the first embodiment of the compact quick folding step stool 100 of the present invention. In this first embodiment of the compact quick folding step stool 100, the left stabilizing stand pivot 165 and the right stabilizing stand pivot 175 each preferably rotate roughly five degrees past vertical, so that they are angled toward the center of the step 150 to provide improved lateral stabilization. However, other positions with a roughly vertical orientation are also suitable for use, and may be preferable depending on the hardware configuration of the stabilizing stands and their respective pivots. Additionally, it is possible to configure the stabilizing stands to be positionable to multiple final positions, or to provide a locking mechanism to further increase stability with a slight increase in the effort required to use the compact quick folding step stool 100. The rear cross member sliding pin 145 is shown engaged with a track in the rotating housing front face 127, which is smooth except for a notch which locks the rear cross member sliding pin 145 in place when fully engaged. The rear cross member sliding pin 145 can be disengaged by lifting the rear cross member 140 to disengage the cross member sliding pin 145 from the notch.

FIG. 3 provides a back view of the first embodiment of the compact quick folding step stool 100 of the present invention. This view provides a view of the rear cross member sliding pin 137, as well as the other parts of the compact quick folding step stool 100 already discussed.

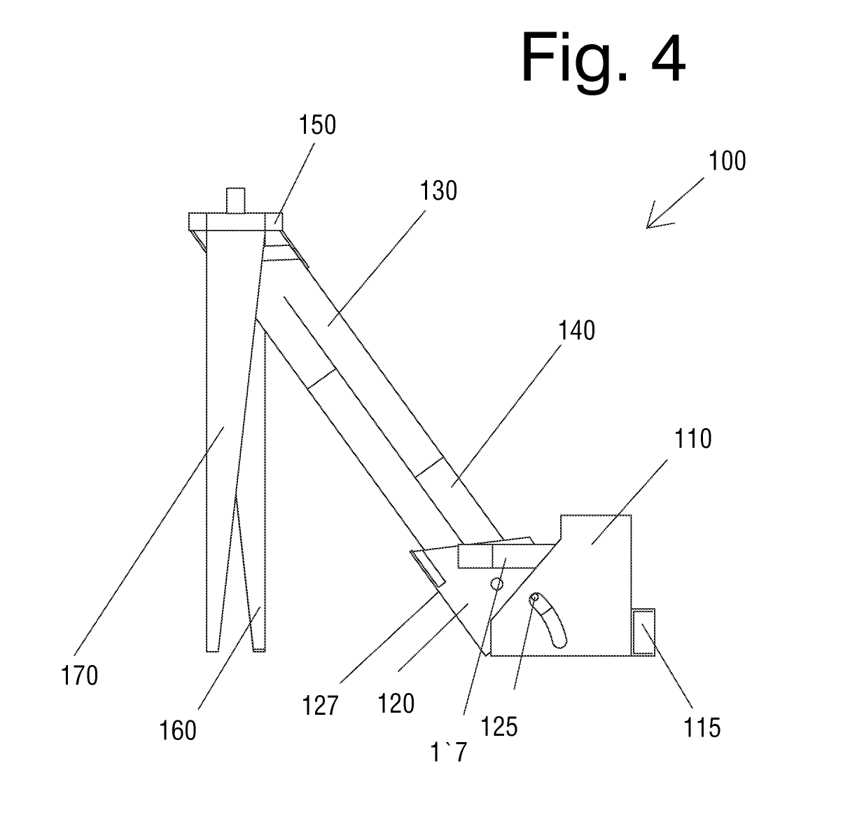

FIG. 4 depicts the first embodiment of the compact quick folding step stool 100 of the present invention from the side. The rotating housing 120 is shown fully rotated out from the mounting brace housing 110. When collapsed, the rotating housing front face 127 is approximately vertical, but when extended, as shown, the housing is rotated away from the mounting brace housing 100, so that the angle between the front face 127 and the ground is approximately 60 degrees. The rear cross member 130 and front cross member 140 maintain the same angle as they extend upward and outward from the rotating housing 120. The cross members 130 and 140 extend upward to approximately three times the height of the mounting brace housing 110, and are surmounted by the step 150 which is oriented to be substantially parallel to the ground.

FIG. 5 illustrates a front view of an application of the first embodiment of the compact quick folding step stool 100 of the present invention when mounted below a row of cabinets 200. The compact quick folding step stool 100 is shown mounted on a rail 500 to provide for the easy relocation of the step stool to any location along the rail 500. Although the compact quick folding step stool 100 can be sized as needed, in this first embodiment it is sized so as to not extend past the overhang under the cabinets 200 when fully retracted. The toe-kick area under the front of a typical block of cabinets is around 3 inches deep, so the step stool 100 is typically designed to be less than 3 inches deep, but can be sized as necessary to account for variations in the size of the toe-kick area on the cabinets it is intended for use with.

In this depiction, the rail 500 is mounted to the back of the cabinet toe-kick area 210, but the rail 500 could also be embedded in the floor, in which case the track mount 115 (FIG. 1) would be mounted on the bottom of the mounting brace housing 110 (FIG. 1). The rail 500 could also optionally be mounted under the top of the toe-kick area, in which case the track mount 115 (FIG. 1) would be mounted on the top of the mounting brace housing 110 (FIG. 1). The track 500 and track mount 115 (FIG. 1) are preferably configured as a roller bearing track, but can optionally be configured as any suitable form of track desired. Additionally, if the rail 500 is sufficiently anchored, it is possible to mount the step stool 100, so that the mounting brace housing 110 (FIG. 1) does not touch the floor. In this case, only the left stabilizing stand 160 and the right stabilizing stand 170 would touch the ground. It is also possible to mount lighting 105 on any part of the folding step stool 100 or on the track 500 to provide lighting to the toe-kick area for safety or for visual effect.

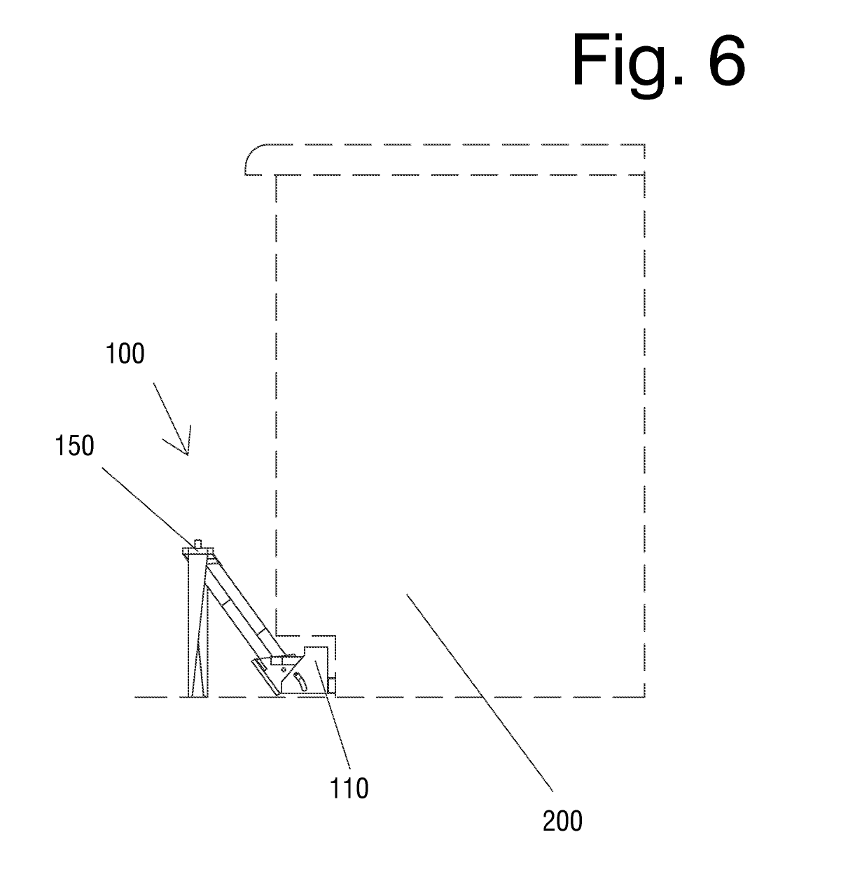

FIG. 6 illustrates a side view of an application of the first embodiment of the compact quick folding step stool 100 of the present invention when mounted below a row of cabinets. The compact quick folding step stool 100 of the present invention is sized to fit into the toe-kick area of the cabinet when collapsed into the mounting bracket 110, but when extended as shown, the step 150 is several inches in front of the cabinets, providing a stable platform with sufficient distance from the cabinets that a person can easily step on the step 150 and reach up to an upper row of cabinets, shelves, or other fixtures which may be mounted above the position of the compact quick folding step stool 100.

To use the compact quick folding step stool 100 in the form of this first embodiment, a user can release the housing catch 117 with his or her foot. If spring loaded, the step 150 will automatically extend, or the step 150 can alternatively be manually extended. After the step is extended, the user can rotate the left stabilizing stand 160 and the right stabilizing stand 170 into position by stepping on the portion of the left and right stabilizing stands 160, 170 that extends past the edge of the step 150. The left and right stabilizing stands 160, 170 will rotate outward around the left stabilizing stand pivot 165 and right stabilizing stand pivot 175 respectively. The user can then stand on the step 150 as needed. To retract the step 150 the user can use his/her foot to push the left and right stabilizing stands 160, 170 outward and around back to their retracted position atop the step 150. The user can then lift the step 150 with the top of his/her foot, causing the front cross member sliding pin 145 to rise out of the interlock which allows the user to push down on the step 150 to push the rear cross member 130 and the front cross member 140 into their retracted positions with the step 150 inside the rotating housing 120. The rotating housing 120 can then be folded inside the mounting brace housing 110 into a fully retracted position.

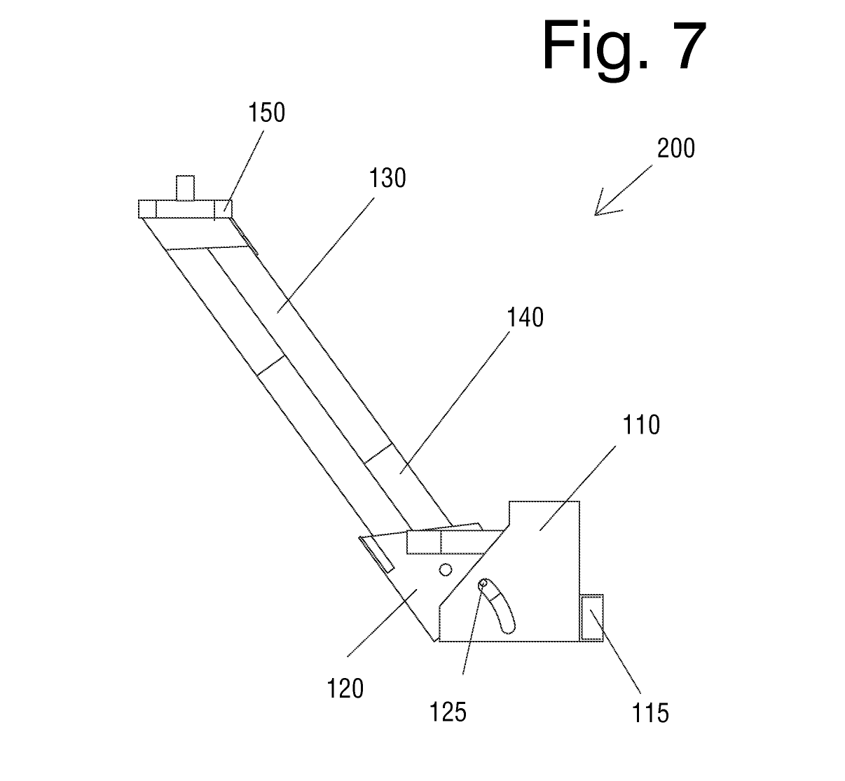

FIG. 7 illustrates a side view of a second embodiment of the compact quick folding step stool 100 of the present invention. In this embodiment of the compact quick folding step stool 100 of the present invention, the track mount 115, mounting brace housing 110, rear cross member 130, and the front cross member 140 are constructed to be sufficiently robust that the left and right stabilizing stands 160, 170 (FIG. 5) are not necessary. This embodiment requires a more robust anchoring to a rail 500 (FIG. 5) or wall, but provides a simpler device which is easier to deploy and retract. A third embodiment is also provided which replaces the front and rear cross members with preferably two telescopic cylinders which serve to extend and retract the step 500. In this third embodiment, the telescopic cylinders are aligned with the rotating housing face 127 (FIG. 1) and the step 150 (FIG. 1) is securely mounted on the opposite end of the telescopic cylinders.

Like the first embodiment, the second and third embodiments are used by extending the step 150. The housing catch 117 is released by the user and the step 150 will automatically extend. The second and third embodiments do not include additional stabilizing stands, so there is no further action necessary before stepping on the step 150 as needed. The retraction process is also like the first embodiment, with the user lifting the step 150 to release the front cross member sliding pin 145 from the interlock, then pressing down on the step 150 to push the rear cross member 130 and the front cross member 140 or the two telescopic cylinders (in locations of 130, 140) into the rotating housing 120. The rotating housing 120 can then be folded back into the mounting brace housing 110 so the device will again be fully retracted.

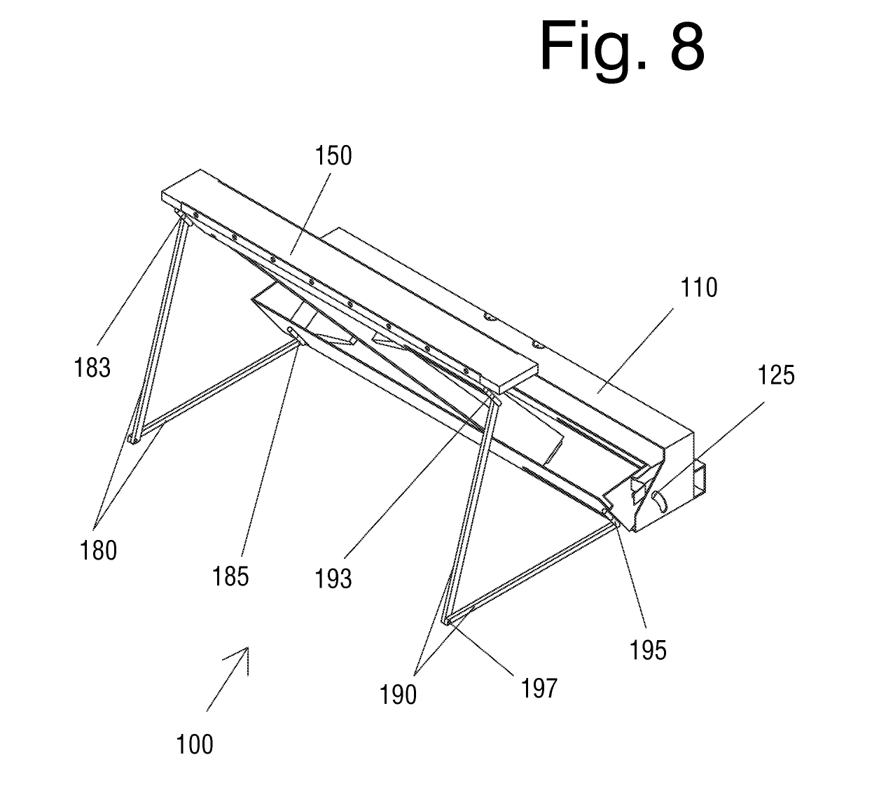

FIG. 8 depicts an isometric view of a fourth embodiment of the compact quick folding step stool 100 of the present invention. In this embodiment, the left and right stabilizing stands 160, 170 are replaced by left folding stand 180 and right folding stand 190. Left folding stand 180 is configured to attach to the step 150 with a left upper hinge 183 and to attach to the rotating housing 120 with a left lower hinge 185. The left folding stand is also configured to fold onto itself around left center pivot 187. The right folding stand 190 is similarly configured, being mounted to the step 150 with a right upper hinge 193 and to the rotation housing 120 with a right lower hinge 195. Also like the left folding stand 180, the right folding stand 190 is configured to fold onto itself around a right center pivot 197. The left folding stand 180 and right folding stand 190 are shown here in FIG. 8 extended in a position configured to brace the step 150.

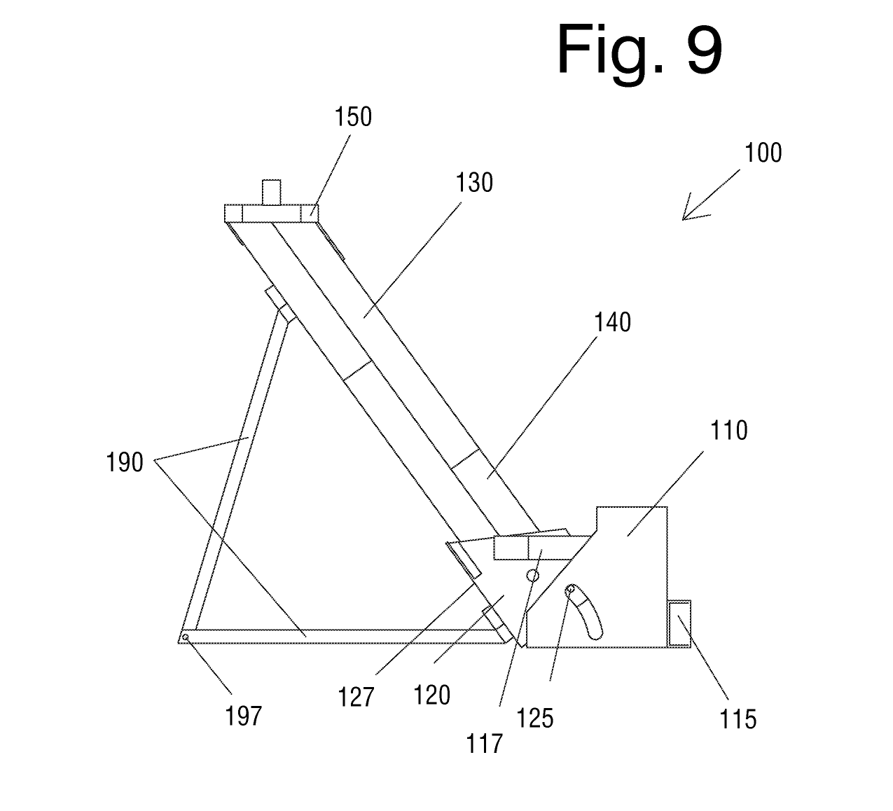

FIG. 9 illustrates a side view of a fourth embodiment of the compact quick folding step stool 100 with the left folding stand 180 (FIG. 8) and right folding stand 190 extended to provide a brace for step 150. Right folding stand is shown bent at right center pivot 197 to form an acute angle bracing the step 150.

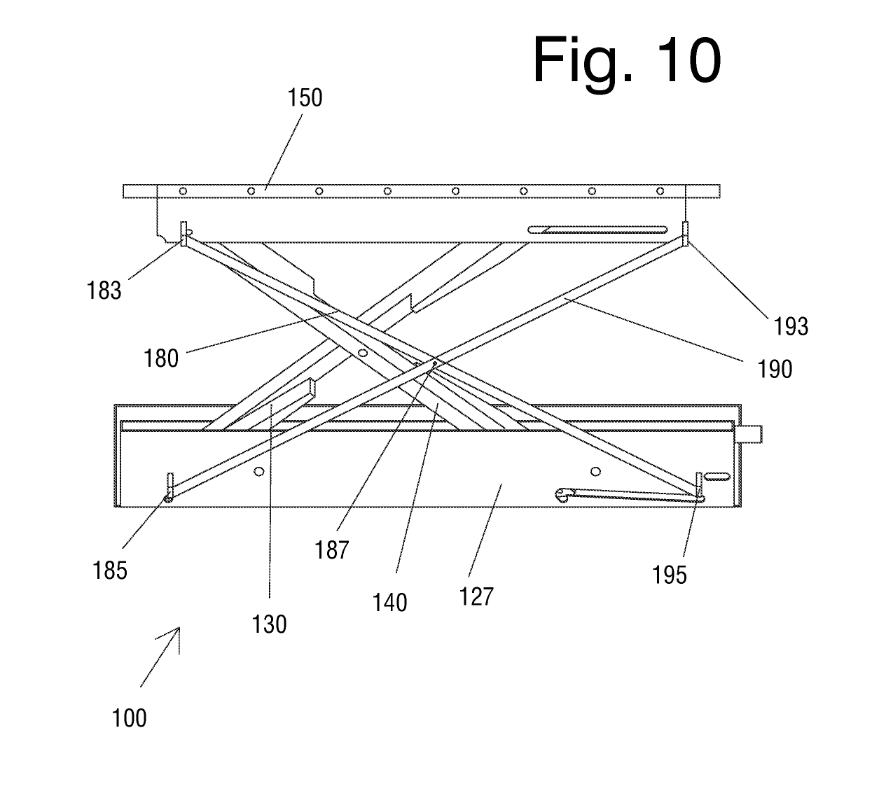

FIG. 10 presents a front view of a fourth embodiment of the compact quick folding step stool 100 of the present invention. In this figure, the left folding stand 180 and right folding stand 190 are shown folded inward against the front of the step stool 100. In this position, the left folding stand 180 and right folding stand 190 are configured to fold up when the step stool 100 is retracted.

To use this fourth embodiment, the user extends the step 150 by releasing the housing catch 117 with his/her foot. The step 150 will automatically extend, and the user can the rotate the left folding stand 180 and right folding stand 190 outward from their positions along the front of the compact quick folding step stool 100 to extend forward from the device. In doing this, the user will cause the left folding stand 180 and right folding stand 190 to align with the ground and provide additional stabilization and support to step 150. When the user retracts the step 150, the user first folds the right folding stand 190 inward to align with the front of the quick folding step stool 100, then folds the left folding stand 180 inward so that it aligns with the front of the device and is positioned in front of the right folding stand 190. The user then lifts the step 150 to disengage the front cross member sliding pin 145 from the interlock, then pushes down on the step 150 to retract the step 150, rear cross member 130 and front cross member 140 into their retracted positions with inside the rotating housing 120, with the left and right folding stands 180,190 crossing in front of the rotation housing 120. The rotating housing 120 can then be folded back into the mounting brace housing 110 to fully retract the device.

FIG. 11 depicts an isometric view of a fifth embodiment of the compact quick folding step stool 100 of the present invention. This embodiment uses left folding stand 180 and right folding stand 190 to stabilize the step 150, and also features a light strip 105 mounted to the side of step 150 to provide enhanced visibility when using the step 150. The light strip 105 may be optionally mounted in any location to provide advantageous light. For example, it may be disposed on any side or top of the step 150, on the mounting brace housing 110, on the rotating housing 120, on the cross members, or other similar location. This embodiment also provides a motor 155 mounted to drive a worm gear which can be remotely activated to extend or retract step 150.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A collapsible stool assembly comprising:
a mounting brace housing adapted to be mounted to a mounting surface;
an extension mechanism with a bottom side connected to said mounting brace housing at laterally opposite ends and configured for movement in a plane at an extension angle of between 30 and 80 degrees up from a horizontal plane, wherein said extension mechanism is configured to fit within said mounting brace housing when not extended for use; and
a step attached to the top side of said extension mechanism and oriented to provide a horizontal surface.

2. The collapsible stool assembly of claim 1 in which said extension mechanism is connected to said mounting brace housing by a rotating housing configured to rotate with respect to said mounting brace.

3. The collapsible stool assembly of claim 1 in which said mounting surface comprises a vertical surface.

4. The collapsible stool assembly of claim 1 in which said mounting surface comprises a horizontal surface.

5. The collapsible stool assembly of claim 1 in which said extension mechanism comprises a first cross brace and a second cross brace configured to form a cross which can be extended outward from said mounting brace housing at an extension angle of between 45 and 60 degrees up from a horizontal plane.

6. The collapsible stool assembly of claim 1 in which said extension mechanism comprises a first extending cylinder connected to a first end of said mounting brace housing and a second extending cylinder connected to a second end of said mounting brace housing and in which said first extending cylinder and second extending cylinder can be extended outward from said mounting brace housing at an extension angle of between 45 and 60 degrees up from a horizontal plane.

7. The collapsible stool assembly of claim 1 in which the stool assembly has a depth of no more than 5 inches when collapsed.

8. The collapsible stool assembly of claim 1 further comprising: a left stabilizing stand and a right stabilizing stand rotatable attached to said step, wherein said left and right stabilizing stands can be positioned horizontally along the top of said step, and wherein said left and right stabilizing stands can separately be rotated to extend downward from said step at an angle of less than 30 degrees from vertical.

9. The collapsible stool assembly of claim 2 further comprising:
a left folding stand with a top end and a bottom end; and
a right folding stand with a top end and a bottom end, wherein:
said left and right folding stands are each configured with a pivot between said top end and bottom end;
said left and right folding stand top ends are rotatably mounted on the front of said step at laterally opposite ends of said step with a left and right top rotatable mount;
said left and right folding stand top ends are rotatably mounted on the front of said rotating housing at laterally opposite ends of said rotating housing with a left and right bottom rotatable mount;
said left top and bottom rotatable mounts and said right top and bottom rotatable mounts, allow the left and right folding stands to rotate around an axis; and
said left and right folding stands can be alternately be positioned to extend outward perpendicularly to said mounting brace housing or to lie substantially parallel to said mounting brace.

10. The collapsible stool assembly of claim 1, further comprising a rail configured to attach to said mounting surface, wherein said mounting brace housing comprises a track mount configured to slidingly engage with said rail.

11. The collapsible stool assembly of claim 10, wherein said track mount is mounted on the back of said mounting brace housing.

12. The collapsible stool assembly of claim 10, wherein said track mount is mounted on the bottom of said mounting brace housing.

13. The collapsible stool assembly of claim 10, wherein said track mount is mounted on the top of said mounting brace housing.

14. The collapsible stool assembly of claim 1, further comprising a motor configured to extend said extension mechanism from said mounting brace housing.

15. The collapsible stool assembly of claim 1, further comprising a light element and a power source.

16. A collapsible stool assembly comprising:
a mounting brace housing comprising a rearward-facing track mount, wherein said track mount is adapted to be mounted to a vertical surface;
a first cross member and a second cross member mounted in a cross configuration to provide for movement in a plane at an extension angle of between 30 and 60 degrees up from a horizontal plane;
a rotating housing configured to rotate with respect to said mounting brace;
a manually releasable housing catch to retain said rotating housing within said mounting brace housing until released;
a step attached to the top side of said first cross member and said second cross member and oriented to provide a horizontal surface;
a left folding stand rotatably connected at a top end to said step and at a bottom end to said rotatable housing; and
a right folding stand rotatably connected at a top end to said step and at a bottom end to said rotatable housing; wherein said mounting brace housing is mounted to said vertical surface with a track; wherein said collapsible stool assembly has a depth of no more than 5 inches when collapsed; wherein said mounting brace housing is configured to receive said rotating housing, said first cross member, said second cross member, said step, said left folding stand, and said right folding stand upon collapsing of said collapsible stool assembly.

17. A method for using a collapsible stool assembly comprising:
releasing a housing catch to allow a rotating housing to be rotated forward from a position within a mounting brace housing;
extending a step from said rotating housing upward at an extension angle of between 30 and 60 degrees from a horizontal plane;
rotating a left stand from a collapsed position to an extended position to support said step; and
rotating a right stand from a collapsed position to an extended position to support said step.

18. A method as in claim 17 further comprising releasing an interlock to allow said step to retract back into said mounting brace housing.

19. A method as in claim 18 further comprising:
folding said left stand and said right stand inward to align with the front of said collapsible stool assembly;
lifting said step to disengage a front cross member sliding pin from said interlock; and
manually pushing downward to retract said left stand, said right stand, and said step into said mounting brace housing.

20. A method as in claim 17 further comprising:
providing a rail for attaching said housing to a surface; and
positioning said mounting brace housing on said rail as desired.
